(19) United States
(12) Patent Application Publication
(10) Pub. No.: US 2007/0247674 A1
(43) Pub. Date: Oct. 25, 2007

(54) SCANNING METHODS FOR SCANNERS

(75) Inventor: Huan Liu, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/736,911

(22) Filed: Apr. 18, 2007

(30) Foreign Application Priority Data
Apr. 19, 2006 (TW) TW95113916

(51) Int. Cl. H04N 1/04

(52) U.S. Cl. 358/483; 358/474

(57) ABSTRACT

A scanning method for a scanner is provided. The scanner comprises a first charge coupled device (CCD) and a second CCD. First, the scanner is set to scan at a first resolution. A first pixel matrix with the first resolution is obtained by the first CCD, and a second pixel matrix with the first resolution is obtained by the second CCD. Then, each pixel of the first matrix is merged with a corresponding pixel of the second matrix to output an output pixel matrix with the first resolution.

### BACKGROUND OF THE INVENTION

1. Field of the Invention

The invention relates to a scanning method for a scanner, and in particular to a quick scanning method for a scanner at a low resolution using two charge coupled devices (CCDs).

2. Description of the Related Art

Most current scanners use a staggered charge coupled device (CCD) to serve as a photo element. By merging pixels of two CCDs, a scan resolution equal to two times the highest optical resolution of each CCD can be obtained. For example, two CCDs each having a resolution of 600 dpi are merged to obtain a resolution 1200 dpi.

When a resolution of a scanning image is equal to or lower than 600 dpi, the scanner performs scan operations using only one CCD. When the resolution is adjusted to 300 dpi, the scanner uses one CCD and notifies the used CCD to send data with only 300 dpi by timing adjustment. According to imaging principles of CCDs in a photo element, the relationship between exposure time and exposure brightness of the photo element is linearity. When an image with a resolution of 300 dpi is scanned by one CCD, two adjacent pixels of the same CCD are merged by timing adjustment. Compared with an image with a resolution of 600 dpi, the image scanned at 300 dpi requires half the exposure time, and brightness of a pixel obtained by merging the two adjacent pixels satisfies scan requirements, thus scan speed is increased.

When a resolution of a scanning image is equal to or lower than 600 dpi, one of two CCDs is used, and the other remains idle, resulting in a low CCD utility rate. Moreover, exposure time becomes longer because only one CCD is used.

### BRIEF SUMMARY OF THE INVENTION

A scanning method for a scanner is provided. A scanner comprising a first charge coupled device (CCD) and a second CCD is set to scan at a first resolution; a first pixel matrix with the first resolution is obtained by the first CCD, and a second pixel matrix with the first resolution is obtained by the second CCD; each pixel of the first matrix is merged with a corresponding pixel of the second matrix to output an output pixel matrix with the first resolution.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing charge coupled devices (CCDs) and pixels of a scanned document in a staggered CCD scanner;

FIG. 2A is a schematic view showing a conventional scan operation with a resolution which is two times the resolution of one single CCD in the staggered CCD scanner of FIG. 1;

FIG. 2B is a schematic view showing a conventional scan operation with a resolution equal to the highest resolution of one single CCD by the staggered CCD scanner of FIG. 1;

FIG. 2C depicts the relationship between exposure time and exposure brightness of a photo element;

FIG. 3A is a schematic view showing an exemplary embodiment of a scan operation with a resolution equal to the highest resolution of one single CCD by the staggered CCD scanner of FIG. 1 of this invention; and

FIGS. 3B and 3C are schematic views showing an exemplary embodiment of a scan operation with a resolution which is a half the resolution of one single CCD by the staggered CCD scanner of FIG. 1 of this invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

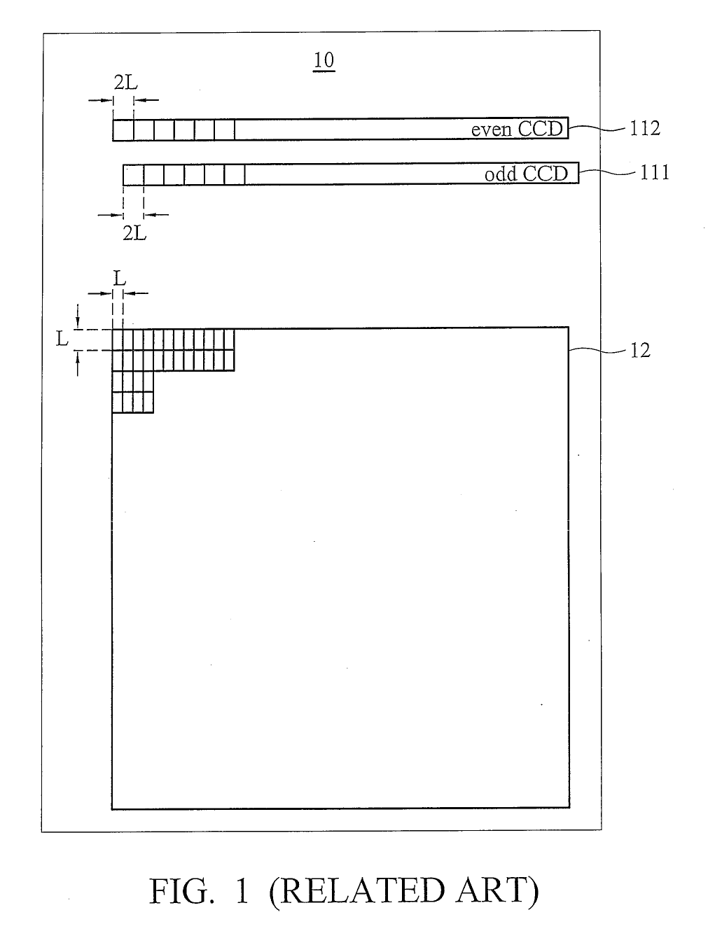

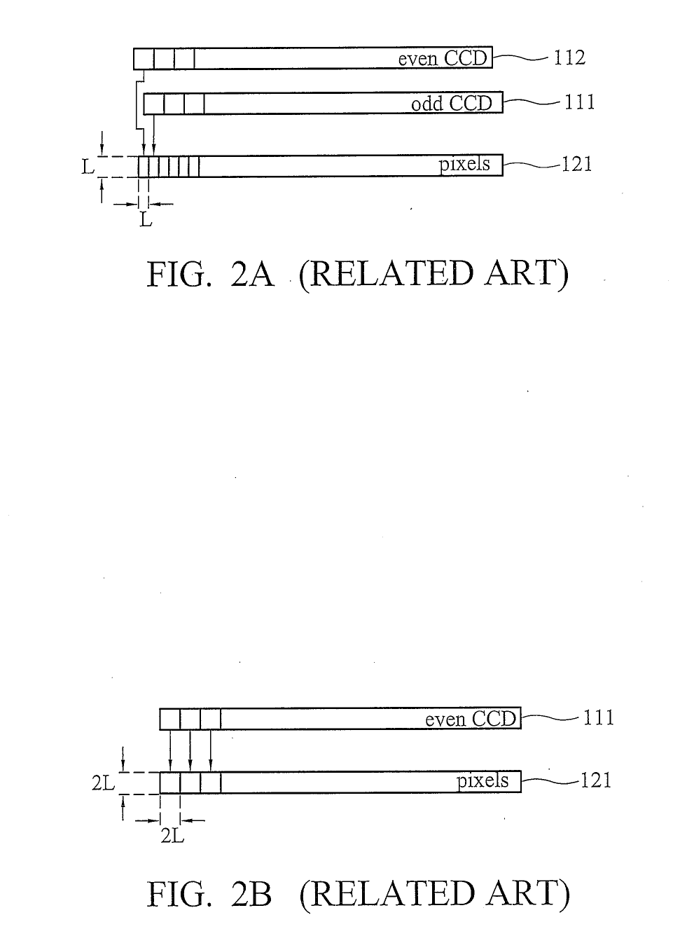

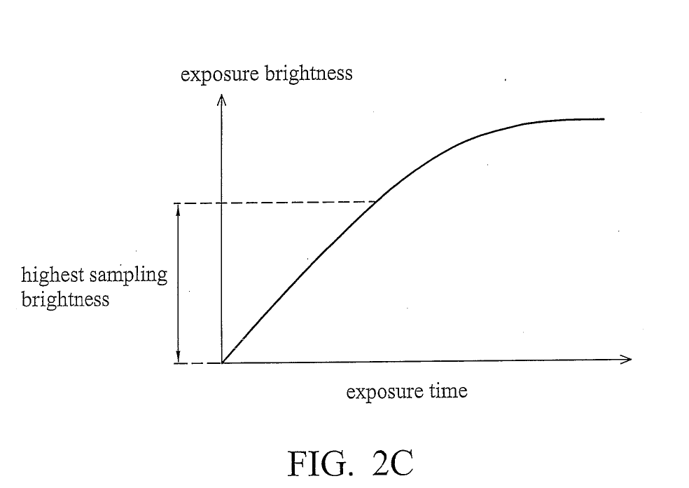

FIG. 1 is a schematic view showing charge coupled devices (CCDs) and pixels of a scanned document in a staggered CCD scanner 10. An odd CCD 111 and an even CCD 112 are disposed in a staggered manner for scanning a document 12. The highest resolution of each of the odd CCD 111 and the even CCD 112 is Adpi. The smallest recognizable pixel width of each CCD unit of the odd CCD 111 and the even CCD 112 is 2 L (=1/A inch). Because the odd CCD 111 and the even CCD 112 are disposed in staggered, the odd CCD 111 and the even CCD 112 are simultaneously used for scanning, and then data sent from the odd CCD 111 and the even CCD 112 can be merged by an addition, thus achieve the document 12 is scanned with an resolution of 2 Adpi, and the smallest recognizable pixel width is L (=½ A inch). FIG. 2A is a schematic view showing a conventional scan operation with a resolution twice the resolution of one single CCD in the staggered CCD scanner 10 of FIG. 1. It is assumed that the highest optical resolution of each of the odd CCD 111 and the even CCD 112 is Adpi. When the staggered CCD scanner 10 uses the odd CCD 111 and the even CCD 112 simultaneously, the highest resolution is 2 Adpi, and the smallest recognizable pixel width is L. In this embodiment, the operation of merging pixels is performed by an addition operation.

FIG. 2B is a schematic view showing a conventional scan operation with a resolution which is equal to the highest resolution of one single CCD by the staggered CCD scanner 10 of FIG. 1. Because only one CCD is used for scanning to obtain a resolution Adpi, the smallest recognizable pixel width is 2 L. The conventional scanner uses one CCD for scanning. The highest value representing color brightness of each pixel is I when voltage applied to the CCD is V and exposure time is T. For example, in a system with 24-bit color representation, the brightness value of each color is from 0 to 255, wherein I=255. Noted that in FIG. 2A, when the conventional scanner uses two CCDs for scanning, the exposure time is T/2 (compared with FIG. 2B) if voltage applied to the CCD is still V.

FIG. 2C depicts the relationship between exposure time and exposure brightness of a photo element. According to imaging principles of CCDs in a photo element, the relationship between exposure time and exposure brightness of the photo element is linear in the range of highest sampling brightness. When an image with a CCD resolution A/2 dpi is scanned by one CCD, two adjacent pixels of the same CCD are merged by timing adjustment. Compared with an image with a resolution Adpi, only one half the exposure time, and brightness of a pixel obtained by merging the two adjacent pixels is required to satisfy scan requirements, thus scan speed is increased.

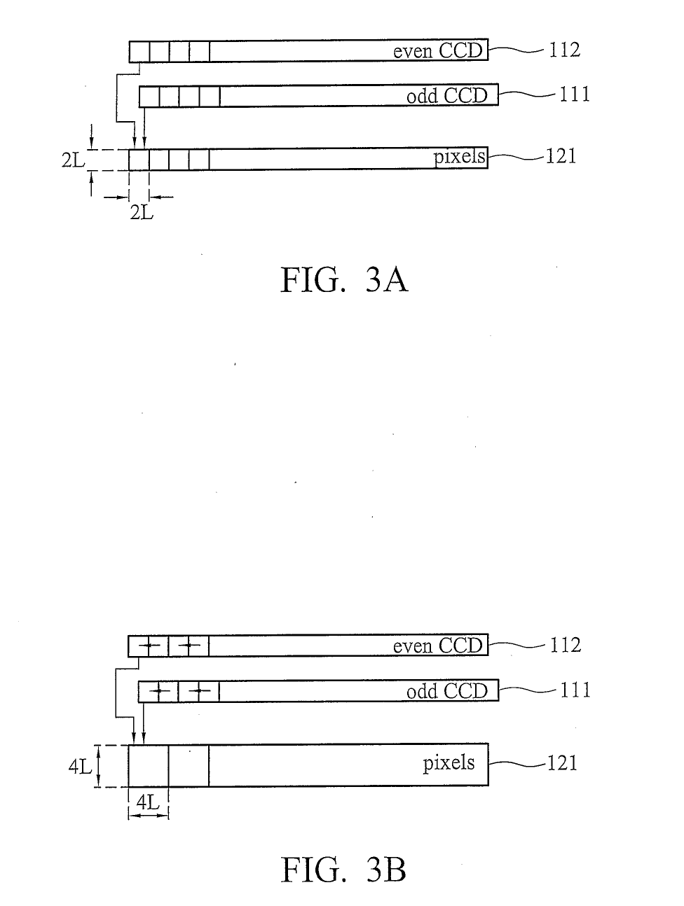

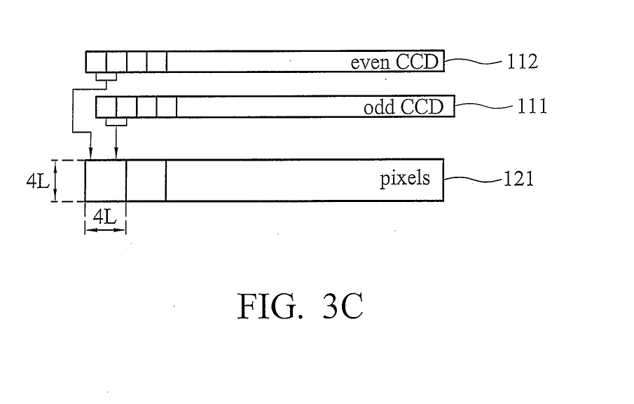

FIG. 3A is a schematic view showing an exemplary embodiment of a scan operation with a resolution equal to the highest resolution of one single CCD by the staggered CCD scanner 10 of FIG. 1. In the embodiment, two CCDs are used simultaneously to obtain a resolution Adpi, and the smallest recognizable pixel width is 2 L. If voltage applied to the CCD is still V and exposure time of the CCD is T/2, the highest value representing color brightness of each pixel is I/2. After the pixels in the corresponding positions are merged by addition, the highest value representing color brightness of each pixel is I.

As described, the exposure time when two CCDs are used according to this embodiment is a half the exposure time when only one CCD is used, thus scan speed is increased.

FIGS. 3B and 3C are schematic views showing an exemplary embodiment of a scan operation with a resolution which is a half of a resolution of one single CCD by the staggered CCD scanner 10 of FIG. 1. It is assumed that a resolution is A/2, and the smallest recognizable pixel width is 4 L. When two CCDs are used simultaneously for imaging, the exposure time is T/4 and decreases by half the exposure time (T/2) when only one CCD is used. In the timing adjustment in FIG. 3B, a pixel with a resolution A/2, which is output from one CCD after merging two adjacent pixels, is merged with a pixel with a resolution A/2, which is output from the other CCD after merging two adjacent pixels. In the timing adjustment in FIG. 3C, each CCD outputs pixels with a resolution A, and two adjacent pixels at the same CCD are merged by software to obtain a pixel with a resolution A/2. Finally, each of the obtained pixels is merged with the corresponding obtained pixels of the other CCD. In this embodiment, the two adjacent pixels are grouped to one set of one odd pixel and a following even pixel in the same CCD.

Moreover, there is an internal line difference n between two CCDs of a staggered scanner. When the even CCD 112 scans a row x, the odd CCD 111 scans a row (x+n). Thus, the timing adjustment cannot be used to merge pixels. Software is required to merge pixels. The internal line difference between the two CCDs is considered when the software is used.

It is assumed the even CCD 112 and the odd CCD 111 scan a document on the j-th row at different time. The i-th pixel on the j-th row are represented by:

Even CCD 112: Pixelᵢⱼ=(Rᵢⱼ, Gᵢⱼ, Bᵢⱼ);

Odd CCD 111: Pixel′ᵢⱼ=(R′ᵢⱼ, G′ᵢⱼ, Bᵢⱼ); and

Merged pixel″ᵢⱼ=(R″ᵢⱼ, G″ᵢⱼ, B″ᵢⱼ).

Because the pixels are merged via software, it is desired to ensure that a value range of the pixel finally output is the same as a value range of an original data output by the scanner. This means the highest brightness is I, such as (0, 255). Thus, a value range of the pixel output from each CCD in this embodiment is adjusted to a half of the value range of the original data A value range of one CCD is set to (0, 127), and that of the other CCD is set to (0, 128). Since the scan time is designated as half the original scan time when the resolution is A/2, a brightness limit value of each color is I/2, and the pixels output from the CCD can be directly added together. Similarly, since the scan time is designated as one fourth the original scan time when the resolution is A/4, a brightness limit value of each color is I/4, and the pixels output from the CCD can be directly added together.

According to the merged pixels in this embodiment, a analysis of signal-to-noise ratio (SNR) is described in the following.

It is assumed that each CCD signal is S, and linear noise N1 and random noise N2 are generated. After adjustment of the value range, the CCD signal becomes n*S, the linear noise N1 becomes n*N1, and the random noise becomes n*N2, wherein n is the adjust factor. After merging the pixels, the CCD signal becomes 2n*S, the linear noise N1 becomes 2n*N1, and the random noise becomes sqrt(2)*n*N2 (=n*N2*n*N2+n*N2*n*N2). The SNR is represented by:

(2n*N1+sqrt(2)*n*N2)/(2n*S)=(2+N1+sqrt(2)*N2)/2S (equation 1)

In FIG. 2B, analysis of an SNR when only one CCD is used is described in the following:

It is assumed that a CCD signal is S, and linear noise N1 and random noise N2 are generated. After adjustment of the value range, the CCD signal becomes 2n*S, the linear noise N1 becomes 2n*N1, and the random noise becomes 2n*N2. The SNR is represented by:

(2n*N1+2n*N2)/(2n*S)=(N1+N2)/S (equation 2)

According to the equations 1 and 2, the SNR is better when two CCDs are used for merging.

As the disclosed embodiments, when two CCDs of a staggered CCD scanner are exposed simultaneously, exposure time is reduced, scan speed is increased, and SNR is lower than in a conventional scanner.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanning method for a scanner, the scanner comprising a first charge coupled device (CCD) and a second CCD, the scanning method comprising:
setting the scanner to scan at a first resolution;
obtaining a first pixel matrix with the first resolution by the first CCD;
obtaining a second pixel matrix with the first resolution by the second CCD; and
merging each pixel of the first matrix with a corresponding pixel of the second matrix to obtain an output pixel matrix with the first resolution.

2. The scanning method as claimed in claim 1, wherein the first and second CCDs have the same optical resolution.

3. The scanning method as claimed in claim 2, wherein an optical resolution of the first CCDs is equal to the first resolution.

4. The scanning method as claimed in claim 2, wherein the first resolution is a half the optical resolution of the first CCDs.

5. The scanning method as claimed in claim 4 further comprising:
merging each odd pixel and a following even pixel in the first CCD to obtain the first pixel matrix with the first resolution;
merging each odd pixel and a following even pixel in the second CCD to obtain the second pixel matrix with the first resolution; and
merging each pixel of the first matrix with a corresponding pixel of the second matrix to obtain the output pixel matrix with the first resolution.

6. The scanning method as claimed in claim 5, wherein value ranges of pixels of the first and second CCDs are lower than a limit value.

7. The scanning method as claimed in claim 6, wherein the limit value is equal to a middle value of a value range of the output pixel matrix.

8. The scanning method as claimed in claim 1, wherein value ranges of pixels of the first and second pixel matrix are lower than a limit value.

9. The scanning method as claimed in claim 8, wherein the limit value is equal to a middle value of a value range of the output pixel matrix.
